(19) United States
(12) Patent Application Publication
(10) Pub. No.: US 2006/0245677 A1
(43) Pub. Date: Nov. 2, 2006

(54) Device for determining axial force, bearing unit having a device for determining axial force, and method determining axial force

(75) Inventors: Steven J. Kenworthy, Ann Arbor, MI (US); Gary G. Chatell JR., Saline, MI (US)

Correspondence Address: CROWELL & MORING LLP;INTELLECTUAL PROPERTY GROUP, P.O. BOX 14300, WASHINGTON, DC, 20044-4300, US

(73) Assignee: NSK Corporation, Ann Arbor, MI (US)

(21) Appl. No.: 11/407,966

(22) Filed: Apr. 21, 2006

Related U.S. Application Data
(60) Provisional application No. 60/675,474, filed on Apr. 28, 2005.

(51) Int. Cl. F16C 41/04

(52) U.S. Cl. 384/448

(57) ABSTRACT

A bearing unit includes first and second rings, a cage seated between the first and second rings, a first sensor for sensing the speed of the first ring, a second sensor for sensing the speed of the cage, and a device that is programmed to determine an axial force on the rings from the speed of the first ring and the speed of the cage. A method for determining an axial force of a bearing unit includes sensing the speed of the first ring of the bearing unit, sensing the speed of the cage of the bearing unit, and determining an axial force on the bearing rings from the speed of the first ring and the speed of the cage.

### CROSS REFERENCE TO RELATED APPLICATIONS

The present application claims priority under 35 U.S.C. § 119 to U.S. Provisional Application No. 60/675,474, filed Apr. 28, 2005, the entire disclosure of which is herein expressly incorporated by reference.

### FIELD OF THE INVENTION

This invention relates to a device for determining axial force, a bearing unit having a device for determining axial force, and a method for determining axial force.

### BACKGROUND OF THE INVENTION

In various applications there is a need to measure axial forces, such as axial loads, in rotating machinery. In the automotive industry, for example, there is a need to measure axial forces in clutches, which are used in powertrain differentials, transfer cases, and transmissions.

Traditional devices for force measurement, such as strain gages, load cells and other transducers, can be bulky and expensive. Additionally, the installation of these traditional devices often requires costly modifications of the components transmitting axial forces.

### SUMMARY OF THE INVENTION

The present invention provides a novel device, a novel bearing unit, and a novel method, for determining an axial force in rotating machinery. The device, bearing unit, and method of the present invention are simple and inexpensive.

According to the present invention, an axial force in rotating machinery can be determined from the speeds of bearing components. In particular, an axial force can be determined from the speeds of one or more of a bearing's rings and balls (or cage). The speed of a bearing's balls can be defined as the speed of a particular bearing ball or as the average speed of two or more bearing balls.

The relationship between the speeds of bearing rings and the speed of the balls (or the cage) is a function of bearing axial force. A bearing typically includes inner and outer rings, and balls arranged between the inner and outer rings. The bearing may also include a cage that holds the balls in place. In operation, one or both of the bearing's rings rotate with respect to the bearing axis, and the balls also rotate with respect to the bearing axis but at a speed that often is different from the ring speeds. If the bearing has a cage, the cage typically rotates with the balls, i.e., the balls and cage rotate at the same speed. In a single-row, angular contact bearing, for example, the ball (or cage) speed and a ring speed are frequently different, and the difference is related to the axial force of the bearing. As the bearing axial force varies, the bearing's effective contact angle changes, causing the relationship between the ball (or cage) speed and the ring speed to change. Thus, the axial force on the bearing is related to, and can be determined from, the relationship between the ball (or cage) speed and a ring speed.

In an angular contact bearing having multiple rows of bearing balls, the speed of each row of bearing balls should be considered. Each row of bearing balls bears a portion of the bearing axial force, and all rows together bear the entire bearing axial force. In other words, the bearing axial force is equal to the sum of the axial forces acting on all rows. The axial force acting on each row can be determined from the speed of the balls (or the cage) in that row, and the bearing axial force is equal to the sum of the axial forces acting on all rows.

For the case of a shaft that has two or more bearings that bear the shaft axial force, the shaft axial force is equal to the sum of the bearing axial forces for all bearings that bear the shaft axial force. Thus, to determine the shaft axial force, the bearing axial forces should be determined and added to obtain the shaft axial force.

The relationship between a bearing's axial force and the speeds of bearing components is described in detail subsequently in connection with the description of the drawings.

In accordance with one aspect of the invention, a bearing unit includes first and second rings, a cage seated between the first and second rings, a first sensor for sensing the speed of the first ring, a second sensor for sensing the speed of the cage, and a device that determines an axial force on the rings from the speed of the first ring and the speed of the cage. The device may be any device suitable for this function. For example, it may be a chip, microprocessor, or computer, which is programmed to accomplish the function. The first ring can be either the inner ring or the outer ring.

In accordance with another aspect of the invention, a bearing unit includes first and second rings, balls seated between the first and second rings, a first sensor for sensing the speed of the first ring, a second sensor for sensing the speed of the balls, and a device that determines an axial force on the rings from the speed of the first ring and the speed of the balls.

In accordance with an additional aspect of the invention, a bearing unit includes two rings, a plurality of cages seated between the two rings, a plurality of sensors for measuring the speeds of one ring and the cages, and a device that is programmed to determine an axial force on the rings from the speeds of the one ring and cages.

In accordance with a further aspect of the invention, a bearing unit includes two rings, a plurality of rows of balls seated between the two rings, a plurality of sensors for measuring the speeds of one ring and two rows of balls, and a device that is programmed to determine an axial force on the rings from the speeds of the one ring and the rows of balls.

Depending on how the bearing is installed and operated, the axial force can be determined from different combinations of ring and ball (or cage) speeds. For example, if the first ring of the bearing rotates while the second ring is held stationary, then the axial force can be determined from the relationship between the speed of the first ring and the speed of the balls (or the cage), in particular from the ratio of the ring speed over the ball (or cage) speed or from the ratio of the ball (or cage) speed over the ring speed.

On the other hand, if both rings of the bearing rotate, then the axial force can be determined from the speeds of both bearing rings, as well as from the speed of the balls (or the cage). As an example, the axial force can be determined from the relative speed of the first ring with respect to the second ring and the relative speed of the balls (or the cage) with respect to the second ring. In particular, the axial force can be determined from the ratio of the relative speed of the first ring over the relative speed of the balls (or the cage) or from the ratio of the relative speed of the balls (or the cage) over the relative speed of the first ring.

Preferably, the relationship between the axial force and the speeds of bearing components is predetermined and stored in the device. In operation, bearing speed data are fed to the device, which then determines the axial force corresponding to the speed data based on the predetermined relationship. The relationship can be predetermined experimentally or based on computation.

There are also other factors that may affect the determination of axial force in addition to the speeds of bearing components. To increase the accuracy of axial force determination, it may be desirable to take into account and compensate for one or more of these factors. For example, axial force determination may be affected by bearing temperature, which changes the dimensions of bearing components. The effects of bearing temperature may be determined experimentally or based on computation, and may be taken into account when the device determines the axial force from the speeds of bearing components. Bearing temperature can be determined or estimated based on a signal from a temperature sensor.

Axial force determination may also be affected by bearing radial load or misalignment. The effects of these two factors tend to be constant and thus may be reduced or zeroed out by an initial calibration of the bearing unit at the factory or when the bearing unit is first installed. However, periodic recalibrations may also be desirable.

Furthermore, axial force determination may be affected by bearing wear, in particular by wear on bearing raceways, balls and cage. The effects of bearing wear may be compensated for with periodic recalibrations.

The bearing unit may include speed sensors for measuring the speeds of bearing components necessary for determining the axial force. For example, if the second bearing ring is stationary and the axial force is determined from the speeds of the first ring and balls (or cage), two speed sensors can be provided to measure the speeds of the first ring and balls (or cage). For another example, if the axial force is determined from the speeds of both bearing rings, as well as from the speed of the balls (or the cage), then three speed sensors may be provided to measure those three speeds. Furthermore, if the axial force is determined from the relative speed of the first ring with respect to the second ring and the relative speed of the balls (or the cage) with respect to the second ring, two speed sensors may be provided to measure the relative speeds. The first sensor can be placed between the first ring and the second ring, and the second sensor can be placed between the balls (or the cage) and the second ring.

Each sensor used to measure the speed of a ring or the cage may be a Hall-effect sensor or a sensor of any suitable type. For example, the sensor placed between the first ring and the second ring may be a Hall-effect sensor which has first and second elements that are attached respectively to the first ring and the second ring. The first and second elements of the Hall-effect sensor may be a magnet and a detector, respectively. The design and structure of a Hall-effect sensor are well known and will not be discussed in detail here.

The speed of bearing balls may also be measured using a sensor of any suitable type, such as an electromagnetic sensor or an optical sensor. In a preferred embodiment, the speed of bearing balls can be measured by counting the number of balls passing by an electromagnetic sensor in a given period of time, or from the time between two adjacent balls passing by an electromagnetic sensor.

Since the rotational and translational speeds of a rotating object are related mathematically, either the rotational speed or the translational speed can be used in the present invention to determine the axial force.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic drawing of a preferred bearing unit of the present invention with a small axial force, in which unit the speeds of bearing components, including a bearing cage, are measured with two speed sensors.

FIG. 2 shows the bearing unit of FIG. 1 with a larger axial force.

FIG. 3 is a schematic drawing of another preferred bearing unit of the present invention, in which unit the speeds of bearing components, including bearing balls, are measured with two speed sensors.

FIG. 4 is a schematic drawing of an additional preferred bearing unit of the present invention, in which the speeds of bearing components, including a bearing cage, are measured with three speed sensors.

FIG. 5 is a schematic drawing of a further preferred bearing unit of the present invention, in which the speeds of bearing components, including bearing balls, are measured with three speed sensors.

FIG. 6 is a schematic drawing of a yet further preferred bearing unit of the present invention, which unit includes two rows of balls with cages.

FIG. 7 is a schematic drawing of a still further preferred bearing unit of the present invention, which unit includes two rows of balls without cages.

### DETAILED DESCRIPTION OF PREFERRED EMBODIMENTS

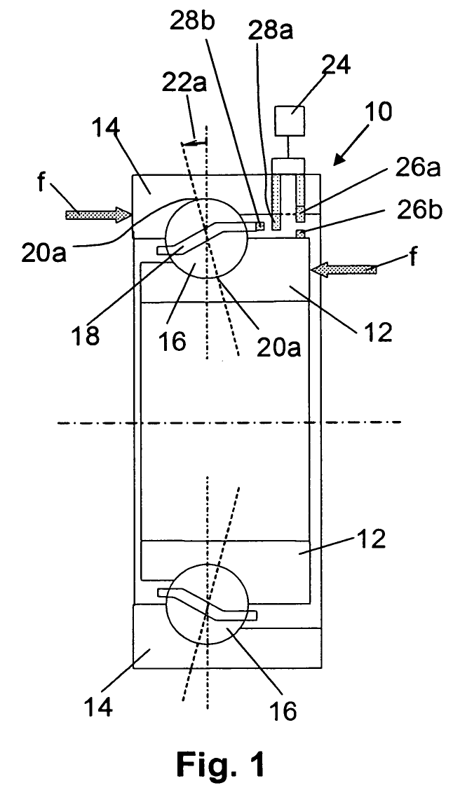

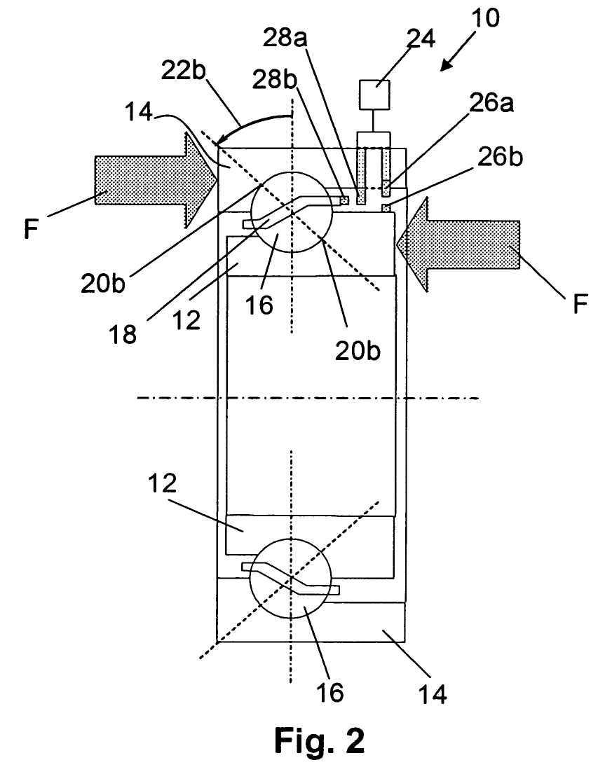

FIGS. 1 and 2 illustrate a preferred bearing unit 10 of the present invention. The bearing unit 10 has an inner ring 12 having an inner raceway, an outer ring 14 having an outer raceway, balls 16 disposed between the inner and outer raceways, and a cage 18 that holds the balls 16 in place. Each of FIGS. 1 and 2 also shows an axial force (or an axial load) f, F applied to the bearing unit 10. A difference between FIG. 1 and FIG. 2 is the magnitude of the axial force. The axial force f in FIG. 1 is smaller than the axial force F in FIG. 2.

In the bearing unit 10, one or both of the inner and outer rings 12, 14 may rotate. In an application where both bearing rings rotate, the inner ring 12 may be mounted on a rotating shaft, and the outer ring 14 may be mounted on a rotating housing. Although the balls 16 and the cage 18, which rotates with the balls, are not attached to a rotating part, they may also rotate with respect to the axis of the bearing unit 10 because the contact points of a bearing ball and a ring move at about the same speed, causing the ball to rotate.

The contact point between a bearing ball and a bearing ring varies with the magnitude of the axial force acting on the bearing unit. As illustrated in FIGS. 1 and 2, as the axial force f, F increases, the contact points 20a, 20b between the outer ring 14 and the balls 16 move radially inwards along the raceway surface of the outer ring 14, and the contact points 20a, 20b between the inner ring 12 and the balls 16 move radially outwards along the raceway surface of the inner ring 12. In terms of the contact angle, which is defined by the contact point, a larger axial force causes the contact angle to increase.

Therefore, the rotating speed of the balls 16 and cage 18 varies not only with ring speeds but also with the contact angle 22a, 22b. In a bearing unit with a stationary inner ring and an outer ring that rotates at a constant speed, for example, a larger axial force produces a larger contact angle, which in turns causes the balls and cage to rotate at a faster rate. In other words, the variation in the magnitude of the axial force changes the ratio of the outer ring speed over the ball (or cage) speed.

Depending on how the bearing unit is installed, the axial force can be determined from different combinations of bearing ring and ball (or cage) speeds. For example, if the outer ring 14 of the bearing unit 10 shown in FIGS. 1 and 2 rotates while the inner ring 12 is held stationary, then the axial force can be determined from the relationship between the outer ring speed and the ball (or cage) speed, in particular from the ratio of the outer ring speed over the ball (or cage) speed or from the ratio of the ball (or cage) speed over the outer ring speed. On the other hand, if the inner ring 12 of the bearing unit 10 rotates while the outer ring 14 is held stationary, then the axial force can be determined from the relationship between the inner ring speed and the ball (or cage) speed, in particular from the ratio of the inner ring speed over the ball (or cage) speed or from the ratio of the ball (or cage) speed over the inner ring speed.

However, if both rings 12, 14 of the bearing unit 10 rotate, then the axial force can be determined from the speeds of both bearing rings 12, 14, as well as from the speed of the balls (or the cage). For example, the axial force can be determined from the relative speed of the outer ring 14 with respect to the inner ring 12 and the relative speed of the balls (or the cage) with respect to the inner ring 12. In particular, the axial force can be determined from the ratio of the relative speed of the outer ring 14 over the relative speed of the balls (or the cage).

The bearing unit 10 may include a device 24 which receives the speed data and determines the corresponding bearing axial force. Preferably, the relationship between the axial force and the speeds of bearing components is predetermined and then stored in the device 24. In view of the teachings of the present application, a person skilled in the art can obtain this predetermined relationship either experimentally or from computation.

The bearing unit of the present invention also includes speed sensors for measuring the speeds of bearing components. The number of speed sensors and their locations depend on which bearing components' speeds are measured. For example, if one of the bearing rings is stationary and the axial force is determined from the speeds of the other ring and balls (or cage), two speed sensors can be provided to measure the speeds of the other ring and balls (or cage), respectively. For another example, if the axial force is determined from the relative speed of one ring with respect to the other ring and the relative speed of the balls (or the cage) with respect to the other ring, then one speed sensor can be provided between the two rings to measure the relative speed of the one ring, and another speed sensor can be provided between the balls (or the cage) and the other ring to measure the relative speed of the balls (or the cage).

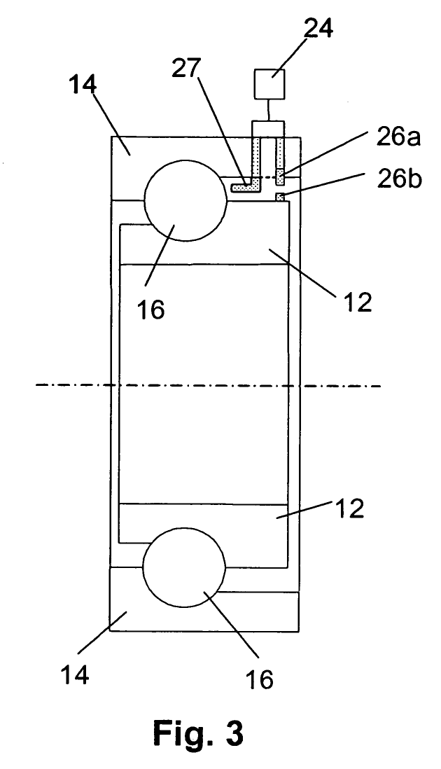

The bearing unit 10 shown in FIGS. 1 and 2 can be used in either of the above two examples. The bearing unit 10 has two speed sensors 26, 28 that can be used to measure the absolute speeds of the cage 18 and outer ring 14 (or the inner ring 12), if the inner ring 12 (or the outer ring 14) is stationary. The two sensors 26, 28 can also be used to measure the relative speed of the outer ring 14 (or the inner ring 12) with respect to the inner ring 12 (or the outer ring 14) and to measure the relative speed of the cage 18 with respect to the inner ring 12 (or the outer ring 14). The bearing unit shown in FIG. 3 is similar to the one shown in FIGS. 1 and 2, except in FIG. 3 the speed of the bearing balls 16 is measured with a sensor 27 while in the one shown in FIGS. 1 and 2 the speed of the cage is measured. This sensor 27 can be used to measure the speed of the balls by counting the number of balls passing by the sensor 27 or by measuring the time between two balls passing by the sensor 27.

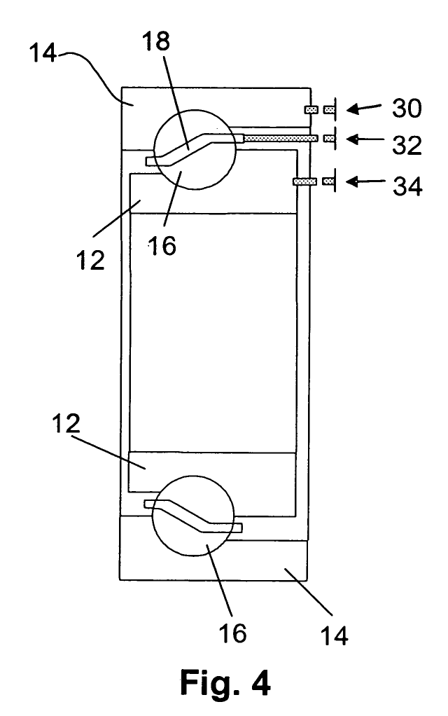

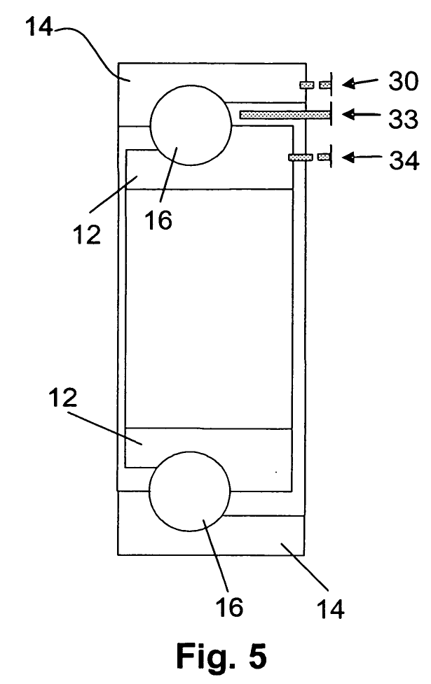

If it is desirable to measure the speeds of both bearing rings and the balls (or the cage), then three speed sensors may be provided. In the bearing unit shown in FIG. 4, for example, three speed sensors 30, 32, 34 are provided to measure the speeds of the bearing rings 12, 14 and the cage 18. The bearing unit shown in FIG. 5 is similar to the one shown in FIG. 4 in that it has three speed sensors, except in FIG. 5 the speed of the balls 16 is measured with a sensor 33 while in FIG. 4 the speed of the cage is measured.

The speed sensors used in the bearing units can be of any suitable type. For example, each speed sensor can be a Hall-effect sensor that has first and second elements. The first and second elements of each sensor may be a magnet and a detector, respectively. In the bearing unit shown in FIGS. 1 and 2, the speed sensors 26, 28 can each be a Hall-effect sensor. The first and second elements 26a, 26b of the first Hall-effect sensor 26 are attached respectively to the inner and outer rings 12, 14. And the first and second elements 28a, 28b of the second Hall-effect sensor 28 are attached respectively to the cage 18 and the inner ring 12.

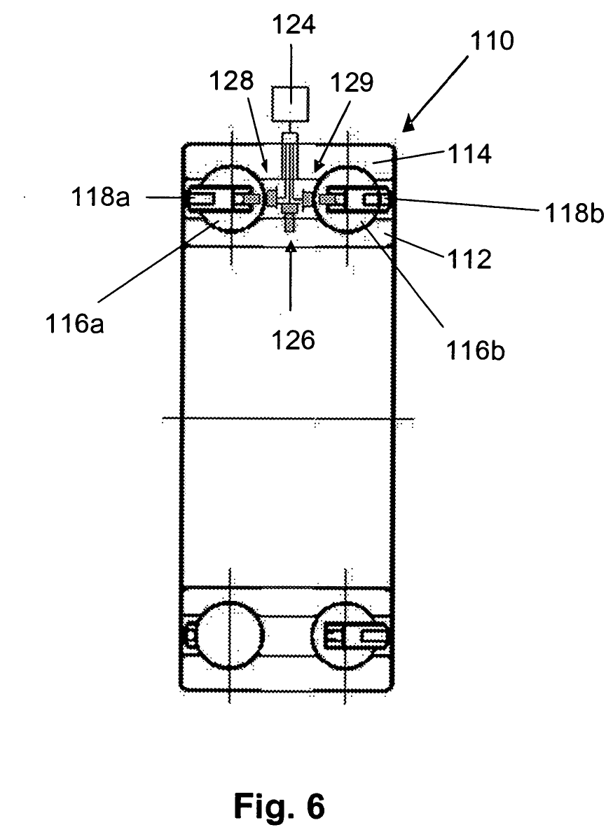

FIG. 6 illustrates another preferred bearing unit 110 of the present invention. The bearing unit 110 has two rows of bearing balls 116a, 116b and two cages 118a, 118b holding the two rows of balls 116a, 116b in place between the two bearing rings 112, 114. The bearing unit 110 includes three speed sensors 126, 128, 129, with the first sensor 126 sensing the speed of one of the rings 112, 114, the second sensor 128 sensing the speed of the first cage 118a, and the third sensor 129 sensing the speed of the second cage 118b. The bearing unit 110 further includes a device 124 that is programmed to determine an axial force on the rings 112, 114 from the speed of the ring 112, 114 and the speeds of the cages 118a, 118b.

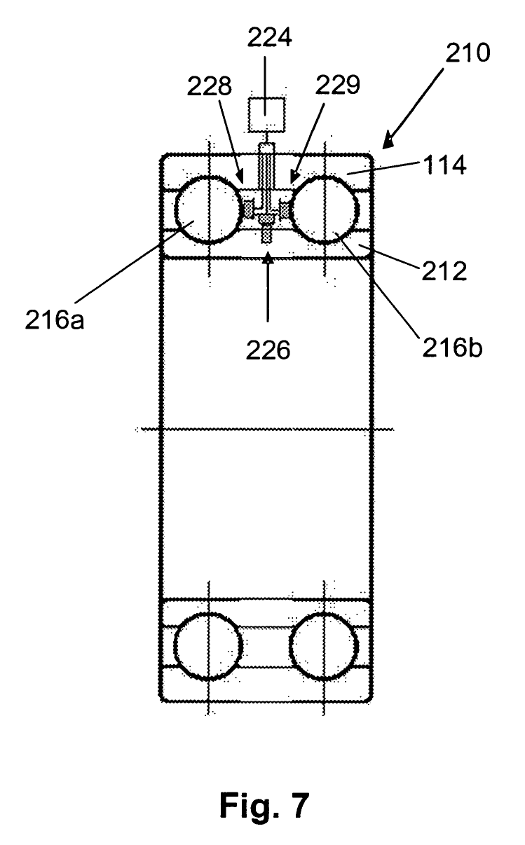

FIG. 7 illustrates a further preferred bearing unit 210 of the present invention. The bearing unit 210 has two rows of bearing balls 216a, 216b placed between the two bearing rings 212, 214. The bearing unit 210 includes three speed sensors 226, 228, 229, with the first sensor 226 sensing the speed of one of the rings 212, 214, the second sensor 228 sensing the speed of the first row of balls 216a, and the third sensor 229 sensing the speed of the second row of balls 216b. The bearing unit 210 further includes a device 224 that is programmed to determine an axial force on the rings 212, 214 from the speed of the ring 212, 214 and the speeds of two rows of bearing balls 216a, 216b.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A bearing unit, comprising:
first and second rings;
a cage seated between the first and second rings;
a first sensor for sensing the speed of the first ring;
a second sensor for sensing the speed of the cage; and
a device that is programmed to determine an axial force on the rings from the speed of the first ring and the speed of the cage.

2. The bearing unit according to claim 1, wherein the speed of the first ring is the relative speed of the first ring with respect to the second ring, and wherein the speed of the cage is the relative speed of the cage with respect to the second ring.

3. The bearing unit according to claim 2, wherein the device is programmed to determine the axial force from a ratio of the first ring speed over the cage speed.

4. The bearing unit according to claim 3, wherein the device contains a predetermined relationship between the axial force and the ratio of the first ring speed over the cage speed.

5. The bearing unit according to claim 2, wherein the speed of the second ring is zero.

6. The bearing unit according to claim 2, wherein the first sensor is placed between the first ring and the second ring, and wherein the second sensor is placed between the cage and the second ring.

7. The bearing unit according to claim 6, wherein the first sensor includes a first Hall-effect sensor having first and second elements that are attached respectively to the first ring and the second ring, and wherein the second sensor includes a second Hall-effect sensor having first and second elements that are attached respectively to the cage and the second ring.

8. The bearing unit according to claim 1, further comprising a third sensor for sensing the absolute speed of the second ring, wherein the speed of the first ring is the absolute speed of the first ring, and wherein the speed of the cage is the absolute speed of the cage.

9. The bearing unit according to claim 8, wherein the device is programmed to determine the axial force from the absolute speeds of the first and second rings and cage.

10. The bearing unit according to claim 8, wherein the device is programmed to determine the relative speed of the first ring with respect to the second ring and the relative speed of the cage with respect to the second ring from the absolute speeds of the first and second rings and cage.

11. The bearing unit according to claim 1, wherein the device is programmed to take into account the effects of at least one of bearing temperature, radial force, misalignment and bearing wear, in the determination of the axial force from the speed of the first ring and the speed of the cage.

12. A device for determining an axial force of a bearing unit having first and second rings and a cage seated between the first and second rings, the device comprising:
a first sensor for sensing the speed of the first ring; and
a second sensor for sensing the speed of the cage, wherein the device is programmed to determine an axial force on the rings from the speed of the first ring and the speed of the cage.

13. The device according to claim 12, wherein the speed of the first ring is the relative speed of the first ring with respect to the second ring, and wherein the speed of the cage is the relative speed of the cage with respect to the second ring.

14. The device according to claim 13, wherein the device is programmed to determine the axial force from a ratio of the first ring speed over the cage speed.

15. The device according to claim 14, further comprising a predetermined relationship between the axial force and the ratio of the first ring speed over the cage speed.

16. The device according to claim 13, wherein the speed of the second ring is zero.

17. The device according to claim 13, wherein the first sensor is placed between the first ring and the second ring, and wherein the second sensor is placed between the cage and the second ring.

18. The device according to claim 17, wherein the first sensor includes a first Hall-effect sensor having first and second elements that are attached respectively to the first ring and the second ring, and wherein the second sensor includes a second Hall-effect sensor having first and second elements that are attached respectively to the cage and the second ring.

19. The device according to claim 12, further comprising a third sensor for sensing the absolute speed of the second ring, wherein the speed of the first ring is the absolute speed of the first ring, and wherein the speed of the cage is the absolute speed of the cage.

20. The device according to claim 19, wherein the device is programmed to determine the axial force from the absolute speeds of the first and second rings and cage.

21. The device according to claim 19, wherein the device is programmed to determine the relative speed of the first ring with respect to the second ring and the relative speed of the cage with respect to the second ring from the absolute speeds of the first and second rings and cage.

22. The device according to claim 12, wherein the device is programmed to take into account the effects of at least one of bearing temperature, radial force, misalignment and bearing wear, in the determination of the axial force from the speed of the first ring and the speed of the cage.

23. A method for determining an axial force of a bearing unit having first and second rings and a cage seated between the first and second rings, the method comprising:
sensing the speed of the first ring;
sensing the speed of the cage; and
determining an axial force on the rings from the speed of the first ring and the speed of the cage.

24. The method according to claim 23, wherein the speed of the first ring is the relative speed of the first ring with respect to the second ring, and wherein the speed of the cage is the relative speed of the cage with respect to the second ring.

25. The method according to claim 23, wherein the step of determining the axial force on the rings includes determining the axial force from a ratio of the first ring speed over the cage speed.

26. The method according to claim 24, wherein the step of determining the axial force comprising determining the axial force from a predetermined relationship between the axial force and the ratio of the first ring speed over the cage speed.

27. The method according to claim 26, wherein the speed of the second ring is zero.

28. The method according to claim 23, wherein the step of sensing the speed of the first ring includes placing a first speed sensor between the first ring and the second ring to sense the relative speed of the first ring, and wherein the step of sensing the speed of the cage includes placing a second speed sensor between the cage and the second ring to sense the relative speed of the cage.

29. The method according to claim 28, wherein the step of placing the first speed sensor between the first ring and the second ring includes attaching first and second elements of a first Hall-effect sensor to the first ring and the second ring respectively, and wherein the step of placing the second speed sensor between the cage and the second ring includes attaching first and second elements of a second Hall-effect sensor to the cage and the second ring respectively.

30. The method according to claim 24, further comprising sensing the absolute speed of the second ring, wherein the speed of the first ring is the absolute speed of the first ring, and wherein the speed of the cage is the absolute speed of the cage.

31. The method according to claim 30, wherein the step of determining the axial force includes determining the axial force from the absolute speeds of the first and second rings and cage.

32. The method according to claim 30, further comprising determining the relative speed of the first ring with respect to the second ring and the relative speed of the cage with respect to the second ring from the absolute speeds of the first and second rings and cage.

33. The method according to claim 23, further comprising taking into account the effects of at least one of bearing temperature, radial force, misalignment and bearing wear, in the determination of the axial force from the speed of the first ring and the speed of the cage.

34. A bearing unit, comprising:
first and second rings;
balls seated between the first and second rings;
a first sensor for sensing the speed of the first ring;
a second sensor for sensing the speed of the balls; and
a device that is programmed to determine an axial force on the rings from the speed of the first ring and the speed of the balls.

35. The bearing unit according to claim 34, wherein the speed of the first ring is the relative speed of the first ring with respect to the second ring, and wherein the speed of the balls is the relative speed of the balls with respect to the second ring.

36. The bearing unit according to claim 35, wherein the speed of the second ring is zero.

37. The bearing unit according to claim 34, further comprising a third sensor for sensing the absolute speed of the second ring, wherein the speed of the first ring is the absolute speed of the first ring, and wherein the speed of the balls is the absolute speed of the balls.

38. The bearing unit according to claim 37, wherein the device is programmed to determine the relative speed of the first ring with respect to the second ring and the relative speed of the balls with respect to the second ring from the absolute speeds of the first and second rings and balls.

39. The bearing unit according to claim 34, wherein the device is programmed to take into account the effects of at least one of bearing temperature, radial force, misalignment and bearing wear, in the determination of the axial force from the speed of the first ring and the speed of the balls.

40. A device for determining an axial force of a bearing unit having first and second rings and balls seated between the first and second rings, the device comprising:
a first sensor for sensing the speed of the first ring; and
a second sensor for sensing the speed of the balls, wherein the device is programmed to determine an axial force on the rings from the speed of the first ring and the speed of the balls.

41. The device according to claim 40, wherein the speed of the first ring is the relative speed of the first ring with respect to the second ring, and wherein the speed of the balls is the relative speed of the balls with respect to the second ring.

42. The device according to claim 41, wherein the speed of the second ring is zero.

43. The device according to claim 40, further comprising a third sensor for sensing the absolute speed of the second ring, wherein the speed of the first ring is the absolute speed of the first ring, and wherein the speed of the balls is the absolute speed of the balls.

44. The device according to claim 43, wherein the device is programmed to determine the relative speed of the first ring with respect to the second ring and the relative speed of the balls with respect to the second ring from the absolute speeds of the first and second rings and balls.

45. The device according to claim 40, wherein the device is programmed to take into account the effects of at least one of bearing temperature, radial force, misalignment and bearing wear, in the determination of the axial force from the speed of the first ring and the speed of the balls.

46. A method for determining an axial force of a bearing unit having first and second rings and balls seated between the first and second rings, the method comprising:
sensing the speed of the first ring;
sensing the speed of the balls; and
determining an axial force on the rings from the speed of the first ring and the speed of the balls.

47. The method according to claim 46, wherein the speed of the first ring is the relative speed of the first ring with respect to the second ring, and wherein the speed of the balls is the relative speed of the balls with respect to the second ring.

48. The method according to claim 47, wherein the speed of the second ring is zero.

49. The method according to claim 46, wherein the speed of the first ring is the absolute speed of the first ring, wherein the speed of the balls is the absolute speed of the balls, and wherein the speed of the second ring is zero.

50. The method according to claim 46, further comprising sensing the absolute speed of the second ring, wherein the speed of the first ring is the absolute speed of the first ring, and wherein the speed of the balls is the absolute speed of the balls.

51. The method according to claim 46, further comprising taking into account the effects of at least one of bearing temperature, radial force, misalignment and bearing wear, in the determination of the axial force from the speed of the first ring and the speed of the balls.

52. A bearing unit, comprising:
first and second rings;
a plurality of cages seated between the first and second rings;
a plurality of sensors for sensing the speed of the first ring and the speeds of the cages;
a device that is programmed to determine an axial force on the rings from the speed of the first ring and the speeds of the cages.

53. A bearing unit, comprising:
first and second rings;
a plurality of rows of balls seated between the first and second rings;
a plurality of sensors for sensing the speed of the first ring and the speeds of the rows of balls;
a device that is programmed to determine an axial force on the rings from the speed of the first ring and the speeds of the rows of balls.
